(19) United States
(12) Patent Application Publication
(10) Pub. No.: US 2004/0088352 A1
(43) Pub. Date: May 6, 2004

(54) Business to business integration via the web

(76) Inventor: Lloyd N. Kurth, Phoenix, AZ (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/410,658

(22) Filed: Apr. 8, 2003

Related U.S. Application Data
(60) Provisional application No. 60/371,112, filed on Apr. 8, 2002.

(51) Int. Cl. G06F 15/16

(52) U.S. Cl. 709/203; 709/229

(57) ABSTRACT

A web services broker system is provided which provides security to existing web services. The system can be easily and transparently deployed on each side of the Internet.

### BACKGROUND

### FIELD OF THE INVENTION

Web Services is a term used to describe application programming interfaces (APIs) exposed to the network, internally or externally, in a way that is network friendly and protocol, language and platform independent. APIs could potentially be provided for any functionality. But, in general, web services are thought to be a tool for business-to-business (B2B) integration.

There are several separate standards that play a part in web services. Each of these adds some capability and together they make up the suite of technologies that is know as web services. Here are the key ingredients:

XML—extensible Markup Language. XML is a metalanguage, a language for describing other languages. It is actually a subset of the Standard Generalized Markup Language (SGML). SGML is very powerful, but also very complex. XML retains much of the power, but is simpler to use. It allows you to design your own markup language for different types of documents. The variations are limitless. XML defines a base set of rules to which all XML documents must adhere. The existence of this base allows for many standard tools for processing XML documents.

SOAP—Simple Object Access Protocol. SOAP is a specification for invoking methods on remote objects. It defines an XML vocabulary for specifying method names, parameter values, return values and exceptions. A client creates a SOAP document that specifies a method invocation and sends it to the server. The server parses the SOAP document to extract all parameters, invokes the method, and returns results to the client as another SOAP document.

HTTP—HyperText Transfer Protocol. HTTP is the core protocol of the World Wide Web. Although SOAP is designed to be protocol independent, it is presently only used with HTTP.

WSDL—Web Services Description Language. WSDL defines an XML vocabulary for describing communication endpoints capable of exchanging messages. The endpoints can be either procedure- or document-oriented. In the case of an API, a procedure-oriented endpoint, a WSDL document describes each method of the API along with its parameters, return values and exceptions. A WSDL document also describes the network protocols used for communication.

UDDI—Universal Description, Discovery and Integration. UDDI is a standard specification that describes interfaces for a business registry. The registry enables one business to register its services and other businesses to discover and integrate to those services. UDDI registries allow for web services to be registered and discovered. One business can register the WSDL that describes its service. Then another business can discover the service, retrieve the WSDL and write a client application that can use the service.

Many tools from multiple sources exist for building web services. Tools range from basic XML parsers to full UDDI implementations. With some “glue code” it is possible to assemble a full web services infrastructure with off-the-shelf components.

### Basic Web Service Topology

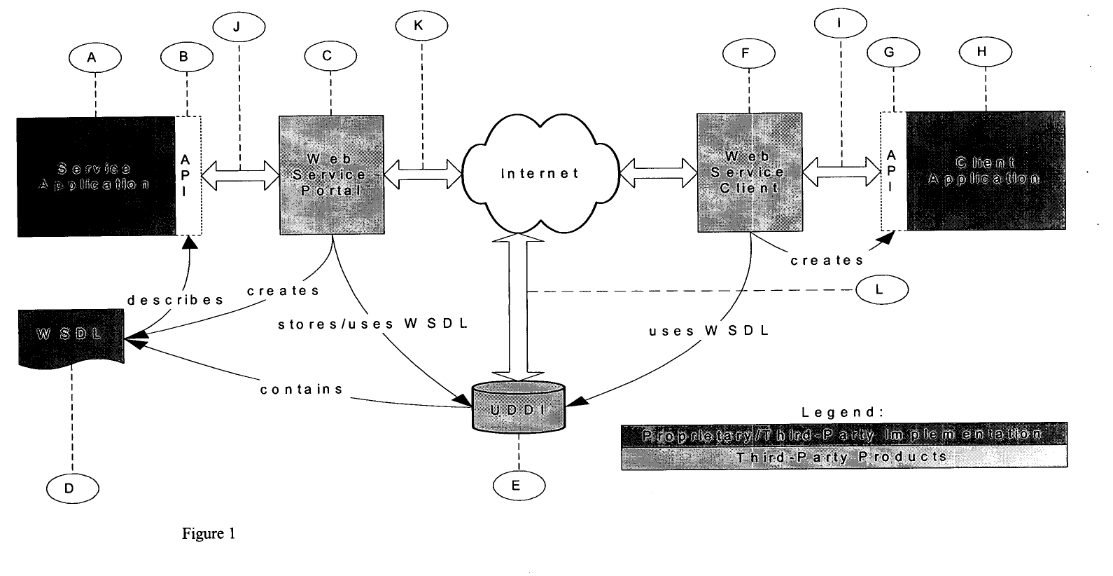

A basic web service consists of a service application that provides a useful service, a client application that makes use of the service, and some infrastructure that allows the two to communicate. FIG. 1 illustrates the topology of a basic web service:

There are a number of components and interfaces in this topology. These are described in more detail:

A Service Application—The service application provides a service. It could be something simple like a stock quote service or something very complex like a purchasing application. The service application is always available to any client that has the ability to use it.

B API—The application programming interface for the service application. The service application must define an interface for its service. For example, this interface may be defined by a set of Java interfaces or CORBA IDL. There are many possibilities.

C Web Service Portal—The web service portal is an infrastructure component that takes a web service request and invokes the API. There are a number of off-the-shelf products that can perform this function. But they typically do much more. A typical portal:

can import the API (typically defined in Java) and create the WSDL that describes the API,

can push/pull WSDL to/from a UDDI registry to register or modify the service definition,

is a servlet that snaps into a standard HTTP server,

will accept a SOAP document containing a web service request, parse and validate the request, invoke the service through the API, get the invocation result, package it as a SOAP document and return it to the client.

D WSDL—The XML document that fully describes the API so a client application has all the necessary information to use the service.

E UDDI—This is a public repository where services are registered and made available to clients. The repository supports full searching capabilities so services can be discovered.

### Web Service Client

The web service client is an infrastructure component that takes a web service invocation, packages it and sends it to the web service portal. As with the portal, there are a number of off-the-shelf products that can perform these functions. A typical web service client:

can search a UDDI registry and pull the WSDL that describes a web service.

can automatically generate a specific language version (typically Java) of the API for use by the client application,

will accept an API invocation, create the SOAP document that defines the web service request, send the request to the portal, wait for the response, parse and validate the response and return it via the API to the client application.

### API

The API used by the client application to invoke the web service. Usually this API is generated from the WSDL by a tool, e.g. the web service client. The API is call-for-call equivalent to the API defined by the service application. But its implementation is different.

### Client Application

The client application that uses the web service provided by the service application. A client application may use many services provided by many service applications physical located at many different addresses on the network. The client application knits these services together to form a higher-level application. And it may itself be a service application exposed to other clients.

The communications interface between the API used by the client application and the web service client could be any network-ready remote procedure call protocol. For example, it may use Java Remote Method Invocation (RMI). If the API is generated by the web service client, this interface would be transparent to the client application.

The communications interface between the web service portal and the service application could be any network-ready remote procedure call protocol. Often the service application is an Enterprise Java Bean (EJB) so the API is an EJB API and the portal simply uses the standard method for invoking an EJB. Many possibilities exist. But this interface would normally be transparent to the service application.

The Internet protocol for communicating with a web service is SOAP/HTTP. SOAP documents are constructed and sent to a servlet via HTTP. Although other possibilities exist, this is by far the prevalent method. HTTPS provides some level of security.

The Internet protocol for communicating with a UDDI registry is SOAP/HTTP. A registry may expose another interface, but normally supports SOAP/HTTP.

### The Need for a Broker

The basic web service topology has some shortcomings that prevent its use for conducting high-value electronic commerce. The issues are related to security.

There is no means to effectively support verification of identity and non-repudiation. SSL client-side public key infrastructure (PKI) has never been widely deployed. PKI issues, such as different trust models, complicate implementation of client-side authentication via SSL. Most SSL implementations requiring authentication allow anonymous clients and use basic (user/password) authentication to identify the user. But basic authentication does not provide the archived, persistent record of interaction required for non-repudiation. High-strength non-repudiation is a business requirement.

The UDDI repository is public and has only minimal support for security. It is difficult to trust web service providers advertising services in the repository and difficult to hide web services from potentially dangerous clients. As with non-repudiation, PKI is required to provide security. Then web service providers and clients can use digital signatures to identify themselves. But managed PKI solutions are not prevalent.

There is a need for an infrastructure that provides solutions to these shortcomings. That is the purpose of Cyclone's Web Service Broker (WSB). The WSB:

Supports manageable PKI. This is a key Cyclone core competency.

Uses highly secure, enterprise-ready transport protocols for communication between client and server. These protocols provide packaging that supports identity verification and non-repudiation.

Manages the exposure of web services only between trusted trading partners. The next section describes the brokered web service topology in detail.

### Brokered Web Service Topology

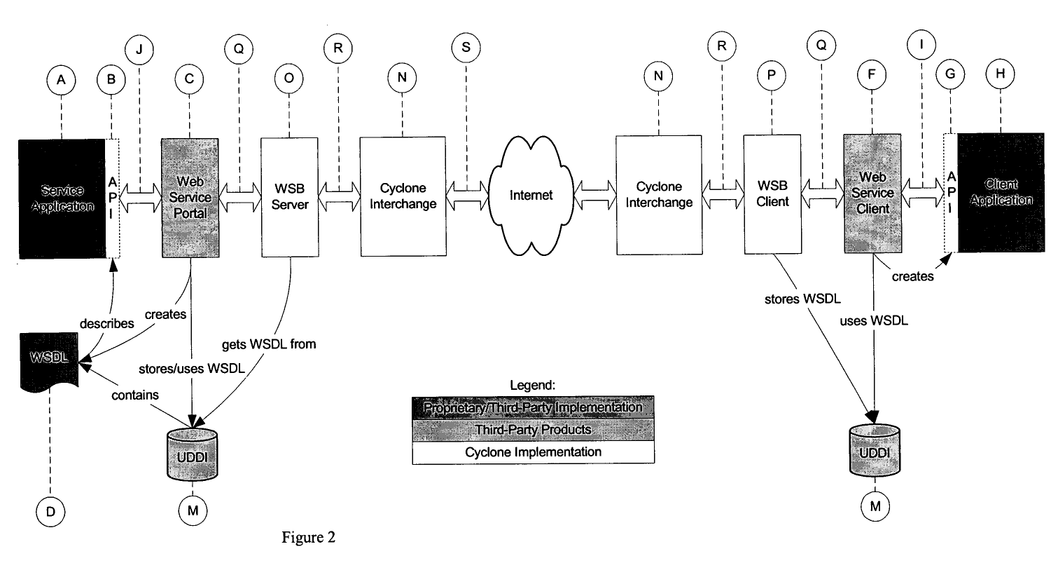

The brokered web service topology retains all the components of the basic web service topology while adding a more robust infrastructure that supports secure B2B protocols. FIG. 2 illustrates the topology of a brokered web service.

This topology contains all the components of the basic web service topology and some additional components. The additions and changes are described in more detail:

A-D These components remain and are identical to those in the basic web service topology.

E UDDI—The public UDDI repository has been replaced by private UDDI repositories.

F-J These components remain and are identical to those in the basic web service topology.

K The SOAP/HTTP protocol is replaced with more secure, robust B2B protocols.

L The interface to the public UDDI repository is on longer required.

M UDDI—The UDDI repositories are private components, one inside the four walls of each enterprise. Private repositories are more secure and controlled. Enterprises are presently deploying private repositories for registration of internal services. This is a flexible solution allowing the service registrations to be easily moved to public repositories when they become more practical.

N Cyclone Interchange—This component is Cyclone's B2B messaging product. It supports highly secure, robust B2B protocols for exchanging messages. The protocol used for messaging between two enterprises is transparent to the other components. Any of the supported protocols can be used. These include ebXML, RosettaNet RNIF, EDIINT/AS2 and others. Protocols that support synchronous operation are most appropriate for web services.

WSB Server—This is one of Cyclone's WSB components. It interfaces with Cyclone Interchange via an API and the web service portal via HTTP. The existence of the WSB server is transparent to the portal. The WSB server can do the following:

search a UDDI repository and pull WSDL that defines a web service,

manage which trading partners have access to a web service,

push WSDL to a trading partner to enable the trading partner to use the web service,

receive an inbound web service request via API from Cyclone Interchange, parse and validate the request and forward it to the web service portal,

intercept the response from the portal and send it back to the trading partner that invoked the web service via Cyclone Interchange.

P WSB Client—This is the other of Cyclone's WSB components. It interfaces to Cyclone Interchange via an API and presents a servlet interface to the web service client. The existence of the WSB client is transparent to the web service client. The WSB client can do the following:

receive a WSDL web service definition from the WSB server and redefine it so the WSB client can intercept requests,

store a WSDL web service definition in a UDDI repository or on the file system,

intercept a web service invocation sent by the web service client and send it to the host trading partner via Cyclone Interchange,

receive a web service invocation response via API from Cyclone Interchange and return it to the web service client.

Q The interface between the WSB server and the web service portal and between the web service client and the WSB client is HTTP. The portal and WSB client are servlets and are invoked by the WSB server and web service client, respectively, via standard HTTP mechanisms. The portal and web service client are not aware of the WSB components' existence.

R The interface between the WSB server and Cyclone Interchange and between the WSB client and Cyclone Interchange is Cyclone Interchange's standard API.

S The interface between the two Cyclone Interchanges is any of the secure transports supported by Cyclone Interchange. There are many. It is possible to use one in one direction and a different one in the other direction.

### SUMMARY

Cyclone's Web Services Broker can be used to provide the best security available to existing web services. The WSB can be easily and transparently deployed on each side of the Internet between the client and server. With the WSB in place, web services are ready for business.

1. A computer network system for exchanging information between a plurality of entities with the use the Internet and a Web service client application, comprising:
a Web service portal;
a transport coupled to the Web service portal and the Web service client application;
a server side component inserted between the Internet and the Web service portal;
a client side component inserted between the Web service client application and the Internet; and
wherein the server side and client side components permit the transport to broker communications between the Web service client application and the Web service to provide security.

2. The system of claim 1, wherein the entities are trading partners.

3. The system of claim 1, wherein the information is in the form of a document.

4. The system of claim 1, wherein the server side component is a WSB server.

5. The system of claim 4, wherein the client side component is a WSB client.

6. The system of claim 1, wherein the security is selected from authentication, encryption, digital signatures, and non-repudiation of receipt.

7. The system of claim 2, wherein the system provides selective exposure of the web service from a first trading partner to a second trading partner.

8. The system of claim 1, wherein the server side component is configured to import a WSDL file that defines the web service, and the first trading partner selects the second trading partner for exposure to the web service client application.

9. The system of claim 8, wherein the server-side component is configured to provide the WSDL file to the client side component using the transport defined for use between the first and second partners.

10. The system of claim 9, wherein when the WSDL is received by the client side component an associated service URL is modified to point to the client-side component.

11. The system of claim 10, wherein the WSDL is published to a repository after the associated service URL is modified.

26. The system of claim 22, wherein the WSB server invokes the portal with HTTP and the web service client invokes the WSB client with HTTP.
